(19) United States
(12) Patent Application Publication
(10) Pub. No.: US 2004/0233272 A1
(43) Pub. Date: Nov. 25, 2004

(54) Image forming apparatus

(75) Inventors: Hisayoshi Fujimoto, Kyoto (JP); Toshihiko Takakura, Kyoto (JP)

Correspondence Address: MERCHANT & GOULD PC, P.O. BOX 2903, MINNEAPOLIS, MN, 55402-0903, US

(73) Assignee: ROHM CO., LTD., Kyoto-shi (JP)

(21) Appl. No.: 10/788,894

(22) Filed: Feb. 27, 2004

(30) Foreign Application Priority Data
Feb. 28, 2003 (JP) 2003-054387

(51) Int. Cl. B41J 13/10; B41J 2/45; B41J 13/26; B41J 2/447

(52) U.S. Cl. 347/245; 347/238; 347/242; 347/244; 347/264

(57) ABSTRACT

An image forming apparatus (X) includes a print head (2) provided with a projection (23a) which is offset with respect to a lens (22a) in an secondary scanning direction (CD) and which protrudes beyond the lens (22a) toward the photosensitive recording medium (4) for abutting against the photosensitive recording medium (4). The projection (23a) moving in contact with the photosensitive recording medium (4) during exposure corrects waviness of the photosensitive recording medium (4).

### FIELD OF THE INVENTION

The present invention relates to an image forming apparatus for forming images by conducting exposure of a photosensitive recording medium.

### BACKGROUND ART

An example of a conventional image forming apparatus is described in JP-A 2001-111876. The image forming apparatus described in this published document comprises an image sensor module, a case for accommodating a photosensitive film, and a print head. The image sensor module is provided for taking an image of an object. The case has an opening for exposing the photosensitive film. The print head has a converging lens and serves to illuminate with light the image recording region of the photosensitive film via the converging lens based on the image data of the object picked up with the image sensor module. With such a configuration, the latent image of the object is formed on the image recording region of the photosensitive film.

However, in such an image forming apparatus, waviness sometimes occurs in the photosensitive film because the film is thin and soft. If such waviness occurs, the distance between the photosensitive film and the converging lens cannot be kept constant. As a result, the focal point of the converging lens does not coincide with the photosensitive film and a clear image is difficult to form on the photosensitive film.

Furthermore, in the image forming apparatus of this type, it is preferred that the image be printed on the entire image recording region of the photosensitive film. Therefore, this point also has to be taken into account when the image forming apparatus is manufactured.

### SUMMARY OF THE INVENTION

It is an object of the present invention to provide an image forming apparatus capable of resolving or alleviating the aforementioned problems.

An image forming apparatus in accordance with the present invention comprises a case accommodating a photosensitive recording medium and having an opening for exposing the photosensitive recording medium, and a print head having a lens for converging light and serving for illuminating the photosensitive recording medium with light. The print head is movable in a secondary scanning direction relative to the case. The print head is provided with a projection, which is offset in the secondary scanning direction with respect to the lens, protrudes beyond the lens toward the photosensitive recording medium and abuts against the photosensitive recording medium.

Preferably, the case has a pair of side walls positioned on both sides of the photosensitive recording medium in the secondary scanning direction, and one of the pair of side walls is formed with an ejection orifice for ejecting the photosensitive recording medium to the outside. The projection may be disposed in a position opposite the ejection orifice across the lens.

Preferably, the photosensitive recording medium has an air vent for releasing the inside air, and the projection has a notch for avoiding interference with the air vent.

Preferably, the size of the projection in the primary scanning direction is less than the size of the opening of the case in the primary scanning direction and no less than the size of the image recording region of the photosensitive recording medium in the primary scanning direction.

Preferably, the lens and the projection are disposed adjacent to each other in the secondary scanning direction.

Preferably, the image forming apparatus in accordance with the present invention may further comprise a support member for supporting the lens, and the projection may be formed integrally with the support member.

Preferably, the image forming apparatus in accordance with the present invention may further comprise a support member having a slit for inserting the lens and a recess connected to the slit, and a supplementary member separate from the support member. When one part of the supplementary member is inserted into the recess, another part of the supplementary member constitutes the projection.

Preferably, the image forming apparatus in accordance with the present invention may further comprise a lens holder which surrounds and supports the lens and is inserted into the slit, the supplementary member abutting against the lens holder.

Preferably, the image forming apparatus in accordance with the present invention further comprises a transparent member for covering the light exit surface of the lens, and the projection is provided at the transparent member.

Preferably, the image forming apparatus in accordance with the present invention further comprises a lens holder which surrounds and supports the lens and is inserted into the slit, and the transparent member abuts against the lens holder.

Other features and advantages of the present invention will become more evident from the following description of the preferred embodiments of the invention.

### BRIEF DESCRIPTION OF THE DRAWINGS

FIG. 1 is an exploded perspective view illustrating an example of an image forming apparatus in accordance with the present invention.

FIG. 2 is a cross-sectional perspective view of the main part of the image forming apparatus shown in FIG. 1.

FIG. 3 is a cross-sectional view of a photosensitive film used in the image forming apparatus shown in FIG. 1.

FIG. 4A is a schematic cross-sectional view of a print head used in the image forming apparatus shown in FIG. 1.

FIG. 4B is a front view of the main part of the print head used in the image forming apparatus shown in FIG. 1.

FIG. 5A is a view illustrating the operation of the print head used in the image forming apparatus shown in FIG. 1.

FIG. 5B is another view illustrating the operation of the print head used in the image forming apparatus shown in FIG. 1.

FIG. 6 is a cross-sectional perspective view of the main part illustrating another example of an image forming apparatus in accordance with the present invention.

### DESCRIPTION OF THE PREFERRED EMBODIMENTS

The preferred embodiments of the present invention will be described hereinbelow with reference to the appended drawings.

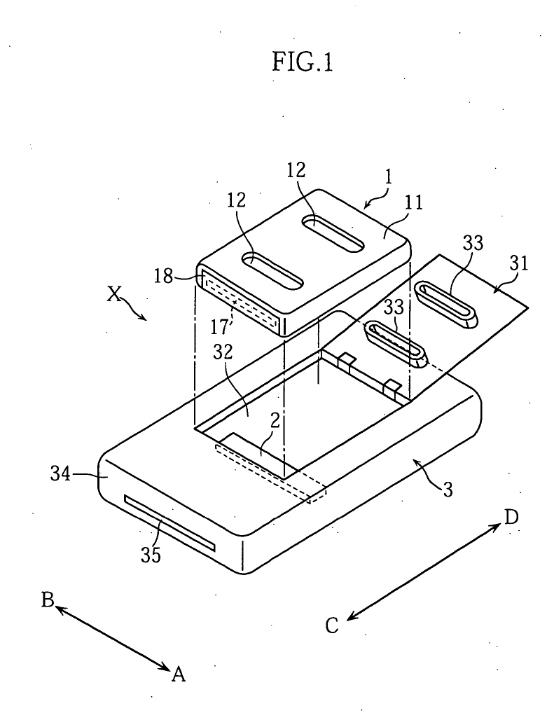

FIG. 1 illustrates an embodiment of an image forming apparatus in accordance with the present invention. The image forming apparatus X of the present embodiment comprises a case 1, a print head 2, and a housing 3.

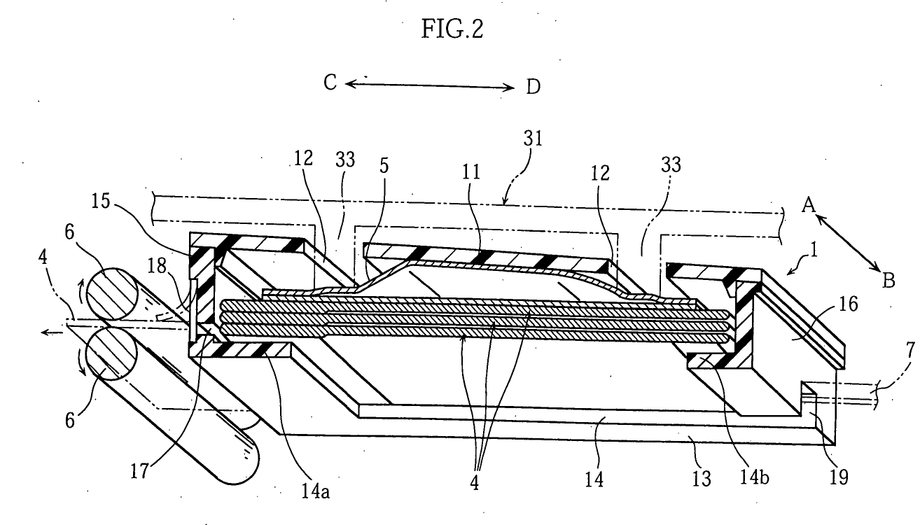

The case 1 is made of a light-impervious synthetic resin. As shown in FIG. 2, the case internally accommodates a stack of photosensitive films 4 and a plate spring 5. The case 1 has an upper wall 11 formed with a pair of openings 12. The case 1 also has a lower wall 13 formed with an opening 14 for exposing the lowermost one of the photosensitive films 4. The case 1 comprises a pair of side walls 15, 16 extending in the primary scanning direction AB and spaced from each other in the secondary scanning direction CD. The side wall 15 is formed with an ejection orifice 17 for ejecting the photosensitive films 4. This ejection orifice is covered with a curtain 18 for preventing dust or the like from penetrating into the case 1. The side wall 16 is formed with a notch 19.

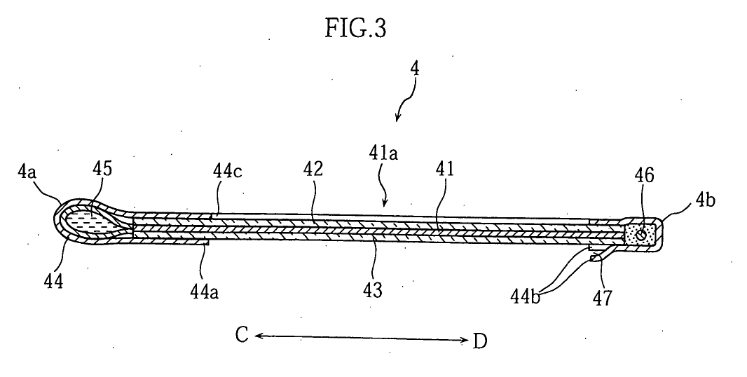

Each of the photosensitive films 4 takes the form of a generally rectangular sheet. As shown in FIG. 3, the photosensitive film comprises a photosensitive layer 41, two transparent covers 42, 43, a mask sheet 44, a developer pack 45, a trap material 46, and an air vent 47. The photosensitive layer 41 is sandwiched between the two transparent covers 42, 43. The mask sheet 44 is laminated on the transparent cover 42 in an intermediate portion thereof in the secondary scanning direction CD and folded and adhesively bonded to the transparent cover 43 at both ends 44a, 44b in the secondary scanning direction CD. Further, the intermediate portion of the mask sheet 44 is provided with an opening 44c. A portion of the photosensitive layer 41 facing the opening 44c is an image recording region 41a. The image recording region 41a is smaller in size than that the opening 14 (see FIG. 2) of the case 1, so that the image recording region can be entirely exposed. The developer pack 45 is provided at an end 4a, in the secondary scanning direction CD, of the photosensitive film 4 while being enveloped by one end 44a of the mask sheet. The trap material 46 is an elongated rod-like member provided at the other end 4b of the photosensitive film 4 in the secondary scanning direction CD and enveloped by the other end 44b of the mask sheet. The air vent 47 serves for releasing the inside air existing between the photosensitive layer 41 and the transparent cover 43, and is provided at the other end 44b of the mask sheet 44. The air vent 47 at the end 44b of the mask sheet 44 may be provided by a central portion, in the primary scanning direction, of the mask sheet which is not adhesively bonded to the transparent cover 43.

As shown in FIG. 2, the plate spring 5 is designed to push down a stack of photosensitive films 4. The spring is disposed between the uppermost one of the photosensitive films 4 and the upper wall 11 of the case 1.

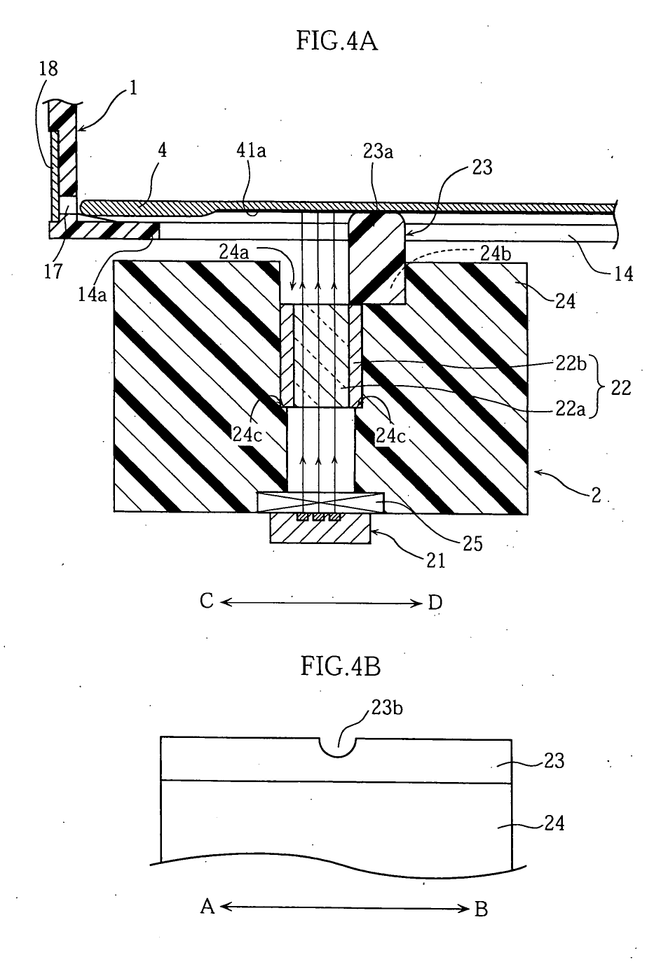

As shown in FIG. 4A, the print head 2 is positioned below the photosensitive film 4 and comprises a light emitter 21, a rod lens array 22, a supplementary member 23, a frame 24, and a shutter 25.

The frame 24 serves to support the light emitter 21, rod lens array 22, supplementary member 23, and shutter 25. The frame includes a slit 24a for inserting the rod lens array 22, a recess 24b connected to the slit 24a, and a step 24c for supporting the lower end of the rod lens array 22. The frame 24 is movable reciprocally in the secondary scanning direction CD by a drive mechanism (not shown in the figure) having a motor.

The light emitter 21 may be used for exposure for forming a color image, and comprises a red light-emitting body, green light-emitting body, and blue light-emitting body for example. Examples of such light-emitters include light-emitting diodes and organic EL light-emitting elements.

The rod lens array 22 comprises a plurality of rod lenses 22a arranged in a row in the primary scanning direction, and a lens holder 22b for surrounding and supporting the plurality of rod lenses 22a. The rod lens array is positioned above the light emitter 21. The rod lenses 22a are disposed opposite the lowermost one of the photosensitive films 4 via the opening 14 of the case 1 at a certain distance therefrom. The lower end of the lens holder 22b abuts against a step 24c.

The supplementary member 23 is formed separately from the frame 24, and the lower end thereof is inserted into the recess 24b of the frame 24. Part of the supplementary member 23 is a projection 23a which protrudes from the upper surface of the frame 24 toward the photosensitive film 4. The supplementary member 23 is disposed opposite the ejection orifice 17 of the case 1 across the rod lens array 22. The supplementary member is offset in the secondary scanning direction CD with respect to the rod lens array 22 to be positioned adjacent to the rod lenses 22a. The lower end of the supplementary member 23 abuts against the upper surface of the lens holder 22b. As shown in FIG. 4B, the projection 23a extends in the primary scanning direction AB and has a distal end formed with a notch 23b. The notch 23b, as will be described hereinbelow, serves to avoid interference between the projection 23a and the air vent 47 (see FIG. 3). The size of the projection 23a in the primary scanning direction is less than the size of the opening 14 in the primary scanning direction, so that the projection 23a can be inserted into the opening 14 of the case 1. The size of the projection in the primary scanning direction is no less than the size of the image recording region 41a of the photosensitive film 4 in the primary scanning direction. The projection 23a has such a height that the focal point of each rod lens 22a coincides with the photosensitive layer 41 when the projection 23a abuts against the photosensitive film 4.

The shutter 25 serves to selectively transmit the light emitted from the light emitter 21 in response to the image data of the object that was picked up, and is composed, for example, of a liquid-crystal panel. The light passing through the shutter 25 is converged on the print head 4 by the rod lenses 22a.

As shown in FIG. 1, the housing 3 has an opening-32 that can be opened and closed by a lid 31 connected to the housing 3. This configuration allows the case 1 to be inserted into and removed out of the housing 3 via the opening 32. The lid 31 has a pair of projections 33 for fixing the case 1 by insertion into a pair of openings 12 of the case 1. The housing 3 has an end wall 34 formed with an ejection orifice 35 for ejecting the photosensitive film 4, which has been subjected to exposure and development, to the outside of the housing 3.

As shown in FIG. 2A, the housing 3 is internally provided with a pair of platen rollers 6 and a push bar 7. The pair of platen rollers 6 serve to transport the photosensitive film 4, while pulling the film out from inside the case 1 for ejection to the outside of the housing 3 via the ejection orifice 35 (see FIG. 1). Furthermore, the pair of platen rollers 6 also play a role of applying a pressure force to the developer pack 45 of the photosensitive film 4 when transporting the photosensitive film 4, squeezing out the liquid developer from the developer pack 45 into a zone between the photosensitive layer 41 and the transparent cover 43 for spreading over the entire image recording region 41a.

The push bar 7 is movable in the secondary scanning direction CD via the notch 19 of the case 1 for pushing the photosensitive film 4 out of the case 1 via the ejection orifice 17.

The image forming apparatus X also comprises an image sensor module (not shown) and a control unit (not shown). The image sensor module picks up an image of the object for outputting image data of the picked-up image of the object. The control unit comprises, for example, a CPU and memory chips of various types on a printed wiring board for performing drive control of the print head 2 and the image sensor module while also providing various types of data processing.

The operation of the image forming apparatus X will be described below.

An object is photographed by using the image sensor module. The image data of the object is stored in the control unit. Then, the print head 2 is moved in the secondary scanning direction CD under the control of the control unit, and the image recording region 41a of the photosensitive film 4 is exposed. As a result, a latent image of the object is formed on the photosensitive layer 41 in the image recording region 41a.

Then the push bar 7 and the pair of platen rollers 6 are driven under the control of the control unit. The photosensitive film 4 is pushed out of the case 1 via the ejection orifice 17 of the case 1 by the push bar 7. Then, the photosensitive film 4 is fed in between the pair of platen rollers 6 and ejected out of the housing 3 via the ejection orifice 35 by driving the platen rollers 6.

In the afore-described ejection process, if the photosensitive film 4 is squeezed by the pair of platen rollers 6, the liquid developer is squeezed out from inside the developer pack 45. The liquid developer then enters the space between the photosensitive layer 41 and transparent cover 43 and spreads toward the other end 4b of the photosensitive film 4. An excess of the liquid developer is trapped by the trap material 46. Because the development of the latent image is conducted in such a manner, the object image is appropriately formed in the image recording region 41a of the photosensitive film 4 and can be viewed from the outside via the transparent cover 42. Even if air is present between the photosensitive layer 41 and the transparent cover 43, the air is gradually drained through the air vent 47 of the photosensitive film 4 due to the squeezing of the photosensitive film 4 between the pair of platen rollers 6. As a result, the liquid developer spreads over the photosensitive layer 41 without hinderance by the air, so that the development process can be conducted smoothly.

In the image forming apparatus X of the present embodiment, the print head 2 during exposure moves in contact with the photosensitive film 4 and the projection 23a of the supplementary member 23. Therefore, even if waviness occurs in the photosensitive film 4, the image forming apparatus X can correct such waviness and maintain a constant spacing between the photosensitive film 4 and each rod lens 22a.

Because the size of the projection 23a in the primary scanning direction is no less than the size of the image recording region 41a of the photosensitive film 4 in the primary scanning direction, the waviness of the print head 4 can be corrected over the entire image recording region 41a. Therefore, it is possible to maintain a constant distance between each rod lens 22a and the photosensitive film 4, so that the focal point of the rod lens 22a coincides with the image recording region 41a of the photosensitive film 4 for forming a clear image on the image recording region 41a. In particular, because the exposure of the image recording region 41a is carried out immediately after correction of the waviness of the photosensitive film 4 in the vicinity of the projection of 23a, the rod lens 22a can be focused more accurately on the image recording region 41a.

The rod lens array 22 is positionally fixed to the frame 24 due to abutment of the supplementary member 23 against the upper end of the lens holder 22b. Therefore, it is not necessary to use a special member separately from the supplementary member 23 as means for fixing the rod lens array 22.

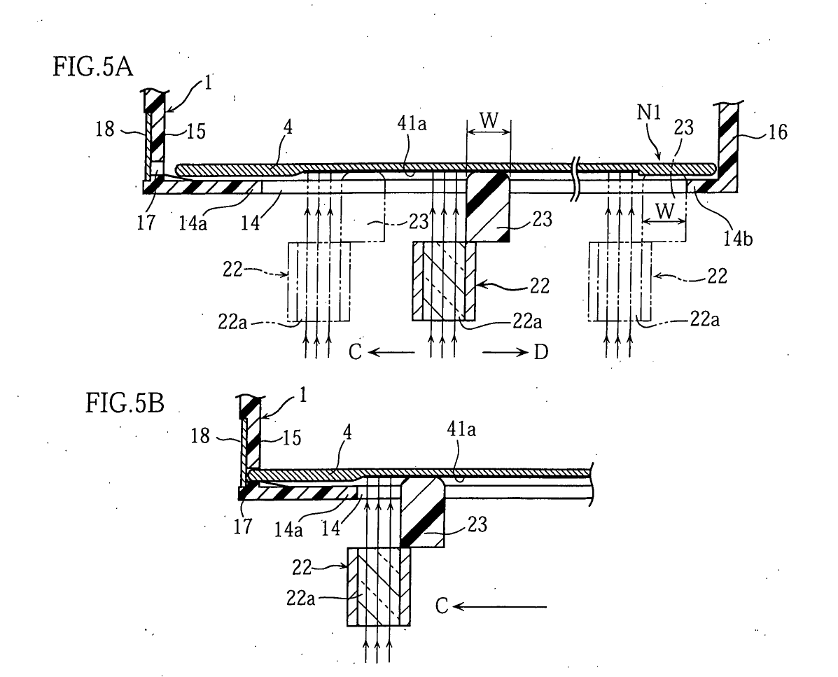

In the image forming apparatus X, the projection 23a of the supplementary member 23 is inserted into the opening 14 of the case 1. Therefore, if the print head 2 moves in the secondary scanning direction D, the projection 23a abuts against the peripheral edge 14b of the case 1, as shown by symbol N1 in FIG. 5A. As a result of such abutment, the rod lens 22a does not move further in the secondary scanning direction D. However, the width W of the supplementary member 23 can be decreased to bring the rod lens 22a close to the peripheral edge 14b of the opening for enabling appropriate light exposure at the end of the image recording region 41a. The abutment of the photosensitive film 4 against the side wall 16 of the case 1 prevents the photosensitive film from shifting in excess of a prescribed amount in the secondary scanning direction D. Therefore, such a shift of the photosensitive film 4 in the secondary scanning direction D does not pose any difficulty on the exposure process of the image recording region 41a.

When the print head 2 moves in the secondary scanning direction C, the rod lens 22a approaches the peripheral edge 14a of the opening without bringing the projection 23a into abutment with the peripheral edge 14a of the opening of the case 1. Therefore, as shown in FIG. 5B, even if the photosensitive film 4 deviates by a comparatively large amount toward the ejection orifice 17, the rod lens 22a can be brought to a position almost directly below the peripheral edge 14a of the opening. Therefore, the image forming apparatus X is capable of conducting an image printing operation appropriately with respect to a portion of the image recording region 41a close to the peripheral edge 14a of the opening.

The notch 23b is provided in the projection 23a to avoid interference between the projection 23a and the air vent 47. As a result, it is unnecessary to limit the movement of the print head 2 for avoidance of interference with the air vent 47.

The present invention being thus described, it is evident that the same may be modified variously. Those modifications should not regarded as a departure from the spirit and scope of the present invention, and all such modifications as would be obvious to those skilled in the art are intended to be contained within the scope of the appended claims.

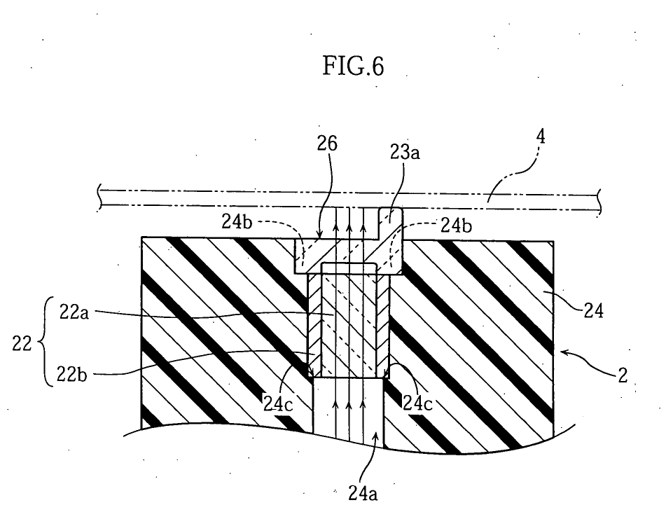

For example, as shown in FIG. 6, the supplementary member 23 of the print head 2 may be replaced with a transparent member 26 for covering the light exit surface of the rod lens array 22, and the transparent member 26 may be provided with a projection 23a. With such a structure, it is possible to protect the rod lenses 22a. Further, if the transparent member 26 is made to abut against the lens holder 22b of the rod lens array 22, then positioning and fixing of the rod lens array 24 can be carried out in a rational manner, similarly to the above-described embodiment. Furthermore, the projection 23a, instead of being provided as a member separate from the frame 24, may be provided integrally with the frame 24. The supplementary member or the transparent member for providing the projection are not limited to those composed of one member and can be composed of a plurality of members.

The structure in which the entire rod lens array 22 is inserted into the slit 24a of the frame 24 is not limiting, and part thereof may protrude from the surface of the frame 24. With such a structure, the frame can be miniaturized and the production cost can be reduced. The lenses are not limited to rod lenses.

What is claimed is:

1. An image forming apparatus comprising:
a case accommodating a photosensitive recording medium and having an opening for exposing said photosensitive recording medium; and
a print head having a lens for converging light and serving for illuminating said photosensitive recording medium with light;
wherein said print head movable relative to said case in the secondary scanning direction; and
wherein said print head is provided with a projection which is offset in the secondary scanning direction with respect to said lens, the projection protruding beyond said lens toward said photosensitive recording medium and abutting against said photosensitive recording medium.

2. The image forming apparatus according to claim 1, wherein said case has a pair of side walls positioned on both sides of said photosensitive recording medium in the secondary scanning direction, one of said pair of side walls being formed with an ejection orifice for ejecting said photosensitive recording medium to outside, and
wherein said projection is disposed opposite said ejection orifice across said lens.

3. The image forming apparatus according to claim 1, wherein said photosensitive recording medium has an air vent for releasing inside air, and
wherein said projection has a notch for avoiding interference with said air vent.

4. The image forming apparatus according to claim 1, wherein a size of said projection in a primary scanning direction is less than a size of said opening of said case in the primary scanning direction and no less than a size of the image recording region of said photosensitive recording medium in the primary scanning direction.

5. The image forming apparatus according to claim 1, wherein said lens and said projection are disposed adjacent to each other in the secondary scanning direction.

6. The image forming apparatus according to claim 1, further comprising a support member for supporting said lens,
wherein said projection is formed integrally with said support member.

7. The image forming apparatus according to claim 1, further comprising a support member having a slit for inserting said lens and a recess connected to the slit, and a supplementary member separate from the support member, wherein when one part of said supplementary member is inserted into said recess, another part of said supplementary member constitutes said projection.

8. The image forming apparatus according to claim 7, further comprising a lens holder for surrounding and supporting said lens, said lens holder being inserted into said slit,
wherein said supplementary member abuts against said lens holder.

9. The image forming apparatus according to claim 1, further comprising a transparent member for covering a light exit surface of said lens,
wherein said projection is provided at said transparent member.

10. The image forming apparatus according to claim 9, further comprising a lens holder for surrounding and supporting said lens, said lens holder is inserted into said slit,
wherein said transparent member abuts against said lens holder.
